(19) United States
(12) Patent Application Publication
(10) Pub. No.: US 2025/0190744 A1
(43) Pub. Date: Jun. 12, 2025

(54) DETERMINING AN ARTIFICIAL INTELLIGENCE (AI) MODEL ARCHITECTURE FROM A PARETO-OPTIMAL CONFIGURATION CURVE

(71) Applicant: International Business Machines Corporation, Armonk, NY (US)

(72) Inventors: Aladin Djuhera, Dachau (DE); Syed Zawad, San Jose, CA (US); Farhan Ahmed, San Jose, CA (US); Fernando Luiz Koch, Palm Beach Gardens, FL (US); Alecio Pedro Delazari Binotto, Munich (DE)

(21) Appl. No.: 18/531,518

(22) Filed: Dec. 6, 2023

(51) Int. Cl. G06N 3/04

(52) U.S. Cl. CPC G06N 3/04

(57) ABSTRACT

A computer-implemented method, according to one embodiment, includes determining, based on capacity profiling information and descriptions associated with a plurality of initial edge devices, a plurality of possible AI model architectures that fulfill memory constraints of the initial edge devices, and generating a pareto-optimal configuration curve based on a sub-set of the possible AI model architectures. In response to receiving a request for determining an AI model architecture for a first edge device, the pareto-optimal configuration curve is used to determine one of the possible AI model architectures with a relatively highest degree of adherence to constraints of the first edge device. The method further includes causing the determined AI model architecture to be deployed to the first edge device.

### BACKGROUND

The present invention relates to artificial intelligence (AI) models, and more specifically, this invention relates to determining an AI model architecture from a pareto-optimal configuration curve to deploy to an edge device performing a task at an edge site.

Edge computing is a distributed information technology (IT) architecture that typically includes a plurality of edge devices with processing capabilities, e.g., routers, laptop computers, cellular phones, cameras, etc. In the landscape of edge computing, client data is often processed at the periphery of a network of the IT architecture, e.g., closer to an originating source of the data, in order to reduce latency and enhance real-time processing capabilities.

### SUMMARY

A computer-implemented method, according to one embodiment, includes determining, based on capacity profiling information and descriptions associated with a plurality of initial edge devices, a plurality of possible AI model architectures that fulfill memory constraints of the initial edge devices, and generating a pareto-optimal configuration curve based on a sub-set of the possible AI model architectures. In response to receiving a request for determining an AI model architecture for a first edge device, the pareto-optimal configuration curve is used to determine one of the possible AI model architectures with a relatively highest degree of adherence to constraints of the first edge device. The method further includes causing the determined AI model architecture to be deployed to the first edge device.

A computer program product, according to another embodiment, includes a computer readable storage medium having program instructions embodied therewith. The program instructions are readable and/or executable by a processing circuit to cause the processing circuit to perform any combination of features of the foregoing methodology.

A system, according to another embodiment, includes a processor, and logic integrated with the processor, executable by the processor, or integrated with and executable by the processor. The logic is configured to perform any combination of features of the foregoing methodology.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 is an edge computing environment, in accordance with one embodiment of the present invention.

FIG. 4 is a flowchart of a method, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for determining an AI model architecture from a pareto-optimal configuration curve to deploy to an edge device performing a task at an edge site.

In one general embodiment, a computer-implemented method includes determining, based on capacity profiling information and descriptions associated with a plurality of initial edge devices, a plurality of possible AI model architectures that fulfill memory constraints of the initial edge devices, and generating a pareto-optimal configuration curve based on a sub-set of the possible AI model architectures. In response to receiving a request for determining an AI model architecture for a first edge device, the pareto-optimal configuration curve is used to determine one of the possible AI model architectures with a relatively highest degree of adherence to constraints of the first edge device. The method further includes causing the determined AI model architecture to be deployed to the first edge device.

In another general embodiment, a computer program product includes a computer readable storage medium having program instructions embodied therewith. The program instructions are readable and/or executable by a processing circuit to cause the processing circuit to perform any combination of features of the foregoing methodology.

In another general embodiment, a system includes a processor, and logic integrated with the processor, executable by the processor, or integrated with and executable by the processor. The logic is configured to perform any combination of features of the foregoing methodology.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as AI model architecture determination code of block 150 for determining an AI model architecture from a pareto-optimal configuration curve to deploy to an edge device performing a task at an edge site. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

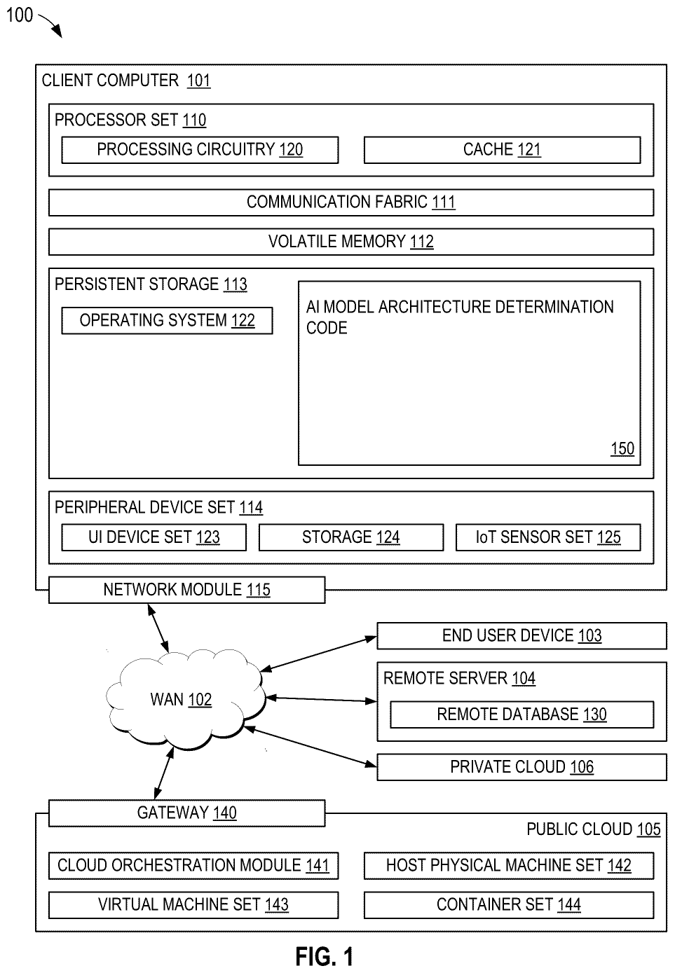

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

Edge computing is a distributed IT architecture that typically includes a plurality of edge devices with processing capabilities, e.g., routers, laptop computers, cellular phones, cameras, etc. In the landscape of edge computing, client data is often processed at the periphery of a network of the IT architecture, e.g., closer to an originating source of the data, in order to reduce latency and enhance real-time processing capabilities.

Edge devices often operate under relatively stringent resource constraints, such as limited memory, processing power, and storage capacity. These constraints can arise sporadically and/or persistently, presenting formidable obstacles to the seamless deployment of resource-intensive AI models at the edge. Conventional techniques of deploying AI models in edge computing environments do not consider these resource constraints. Without such consideration, these techniques are unable to achieve balance between model performance and constrained capacities of edge devices. Accordingly, there is a longstanding need for innovative techniques for finely tuning AI models in order to achieve balance between model performance and constrained capacities at different edge sites.

Achieving relatively optimal AI model performance while adhering to the limitations of edge devices is of paramount importance, particularly in scenarios where real-time processing and localized data operations take precedence. One of the forefront challenges in this context is presented by Foundation Model as a Service (FMaaS) platforms. These platforms serve as pivotal components in deploying AI models on the edge. While these platforms may house a primary “master” AI model, their true potential lies in housing iteratively compressed, pruned, or altered versions of the AI model. These variants might offer slightly reduced performance compared to the master model, yet a critical advantage of these variants is their compatibility with resource-constrained edge devices. By incorporating such adaptable model iterations into FMaaS repositories, a versatility of these platforms is relatively significantly expanded, while catering to a relatively broader spectrum of heterogeneous edge AI devices.

Conventional AI model deployment techniques do not generate and interpolate pareto-optimal decision curves tailored for edge computing environments. Instead, if different model variants are even considered in conventional approaches, the conventional approaches rely on brute force computations which involve computing numerous model variants. These computations are inefficient in that they are time consuming and computation resource intensive to perform. Accordingly, a relatively efficient solution is sought that rapidly identifies a relatively optimal AI model configuration for a given edge device, based on unique capacity constraints of the given edge device.

In sharp contrast to the deficiencies of the conventional techniques described above, the embodiments and approaches described herein include techniques designed explicitly for the nuanced challenges posed by edge computing. These techniques are distinguishable from conventional AI model deployment strategies in that they offer a tailored solution, meticulously constructed to address the intricacies of the limitations of edge devices. By adeptly generating a diverse spectrum of relatively finely tuned model architectures aligned with varying edge resource requirements, these techniques efficiently extract pareto-optimal configuration curves. These curves encapsulate the delicate trade-offs between model latency and task performance. An outcome of these embodiments and approaches includes techniques that not only identify an optimal configuration, but also facilitate the training and deployment of resource-efficient AI model variants that seamlessly match the unique capacity prerequisites of edge environments.

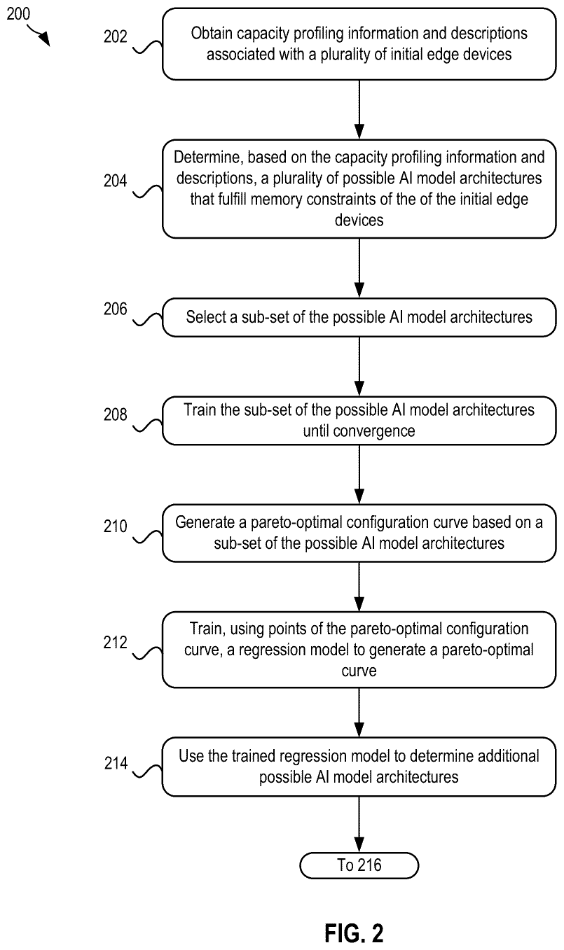

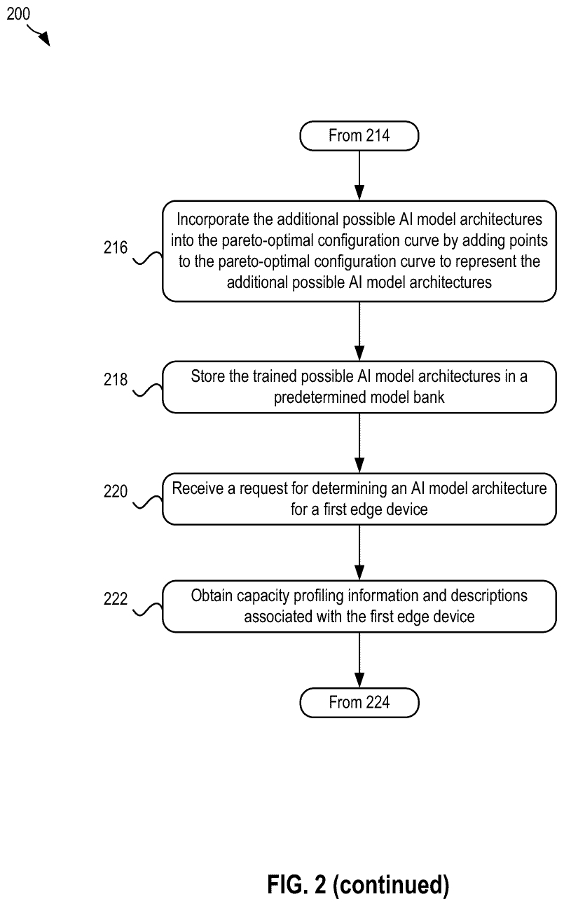

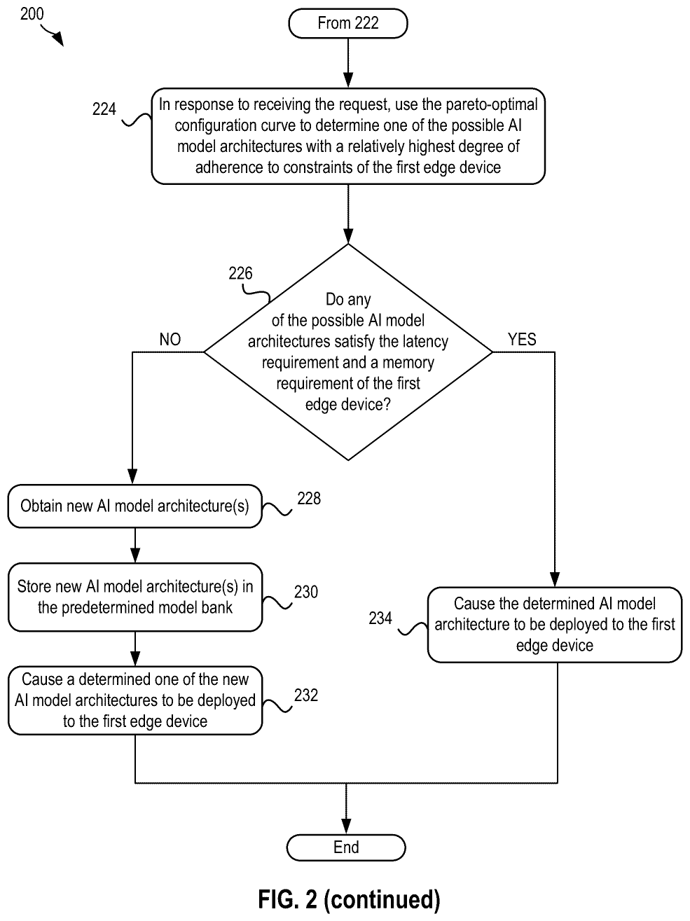

Now referring to FIG. 2, a flowchart of a method 200 is shown according to one embodiment. The method 200 may be performed in accordance with the present invention in any of the environments depicted in FIGS. 1-4, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that operations of method 200 may be performed in an edge computing environment. In some preferred approaches, these operations may be performed in an edge computing environment in which IBM's WATSONX is deployed as a service platform.

A processing circuit performing operations of method 200 may, in some approaches, have access to foundation models of the edge computing environment via application programming interfaces (APIs), e.g., such as a cloud service. An infrastructure of the edge computing environment may, in some approaches, include at least one client edge site (which may be a client site), and preferably includes a plurality of edge sites. The edge sites may each include at least an edge device (“node”) with processing capabilities, and a communication component, e.g., a 4G and/or 5G antenna of a type that would become apparent to one of ordinary skill in the art after reading the descriptions herein. The edge devices are configured to use the communication components to communicate with a cloud site. In some approaches, the cloud site is configured to deploy a FMaaS provisioning instance that processes requests received from the edge devices, e.g., FMaaS requests for feedback about which AI model variants to deploy at the edge sites for performing tasks at the edge sites. Accordingly, the cloud site may include processing resources, e.g., processing circuits of a server, that are configured to communicate with the edge devices, and more specifically controllers of the edge devices in some approaches, using the communication components of the edge sites.

Various approaches described below detail pareto-optimal decision curve generation techniques to relatively improve AI model deployment in such edge computing environments. More specifically, these approaches may be performed in a FMaaS network, in which client edge devices request and deploy a pre-trained (or fine-tuned) foundation model within their respective edge networks. In this setup, the FMaaS provider may need to provision an AI foundation model based on capacity specifications of a given client edge device. Conventional edge computing environment deployments fail to efficiently determine AI foundation models to deploy and therefore experience target problems, e.g., such as how to compute a compressed, pruned or altered fine-grained AI model representation as efficiently as possible. Another target problem that conventional techniques are unable to determine includes how to map a compressed model performance to capacity specifications of the executing edge device, as such techniques do not determine and/or consider pareto-optimal decision curves. These target problems additionally include a failure of conventional techniques to suitably discretize continuous capacity specifications for a more efficient categorization, and additionally a failure to determine a compressed AI model architecture using the performance specifications of considered edge sites.

Operation 202 includes obtaining capacity profiling information and descriptions for at least one edge device of an edge computing environment. In some approaches, the capacity profiling information and descriptions may be received in one or more AI model request(s) from one or more of the edge devices. In some other approaches, the capacity profiling information and descriptions may additionally and/or alternatively be obtained as a result of issuing a request to one or more of the edge devices. For context, the AI model request(s) may be request(s) for instructions of an AI model to deploy by an edge device at an edge site for a predetermined task that is being performed by the edge device at the edge site. For example, these tasks may include, e.g., visual inspection of a product within an industrial setting of the edge site, determining an inference, classification of objects, time-series operations, performance of image analysis, storing and uploading refined images from the edge site to a cloud server, etc. In some preferred approaches, the capacity profiling information includes a list of heterogeneous edge device specifications which are used as compute nodes. More specifically, these edge device specifications may include memory constraint specifications of initial edge devices, e.g., a total memory size of the edge device, an average amount of available memory, a total amount of memory used for one or more tasks performed by the device, a total amount of available memory on the edge device, etc. For context, it may be noted that the “initial edge devices” may be a collection of edge devices that are considered for building a corpus of information, e.g., a structured dictionary, that details a plurality of different possible AI model architectures and when to apply such AI model architectures. The initial edge device may depend on the approach, e.g., edge devices of the edge computing environment, edge devices that are known to perform a predetermined type of task, edge devices that have predetermined performance parameters, edge devices of a predetermined type, etc. It may additionally be noted that, in some approaches described herein, memory is a constraint that is prioritized over all other constraints of the edge devices. However, in some other approaches, the capacity profiling information may additionally and/or alternatively include processing resource constraints, power constraints, compute power, etc. Accordingly, descriptions herein performed with respect to memory may, depending on the approach, additionally and/or alternatively be performed with respect to one or more of these other constraints, e.g., such as compute power. While obtaining the capacity profiling information and descriptions, the capacity profiling information may, in some approaches, specifically be determined by system administrators and/or end-users of the edge device and/or the edge computing environment. In these cases, the capacity profiling information would then be accessed on a list and/or received from user devices associated with such users. In some other approaches, the capacity profiling information may additionally and/or alternatively be defined by a system architecture of the edge device and/or the edge computing environment. Techniques for parsing a system architecture that would become apparent to one of ordinary skill in the art after reading the descriptions herein may be used to identify the capacity profiling information. In some other approaches, the capacity profiling information may additionally and/or alternatively be generated by instructing predetermined capacity profilers in the local edge devices to provide such information. In yet some other approaches, the capacity profiling information may additionally and/or alternatively be determined by load-balancing policies for IoT clusters using techniques that would become apparent to one of ordinary skill in the art after reading the descriptions herein.

The descriptions, in some preferred approaches, preferably include tasks performed by the initial edge devices, e.g., “model tasks” that an AI model deployed at the edge site is able to perform. More specifically, in some approaches, the descriptions may detail information about the tasks, prior predetermined task performance metrics, timestamps, physical operations and/or processing operations associated with performance of the tasks, etc. It should be noted that the tasks that are performed at the different edge sites by the edge devices may differ depending on the approach. For different edge sites that perform the same task, previously used task descriptions may optionally be recycled between devices that are requesting specifications of an AI model to use. In contrast, in order to determine a task that is performed by a given one of the edge sites, in some approaches, end-user agreements and/or requirements may be considered. For example, natural language processing may be performed on such agreements, in some approaches, in order to determine tasks that are performed by the edge device. In some other approaches, the task that is performed by a given one of the edge sites may be determined by determining a purpose of the system associated with the edge device. For example, in some approaches, a determination and/or a result that is produced by the edge device may be considered to determine one or more tasks that are performed by the edge device. In some approaches, techniques that would become apparent to one of ordinary skill in the art after reading the descriptions herein may be used to interpolate tasks performed by an edge device based on a determination and/or a result that is determined to be produced by the edge device. The task that is performed by a given one of the edge sites may additionally and/or alternatively be determined by local tenant application requirements. In yet some other approaches, the task that is performed by a given one of the edge sites may additionally and/or alternatively be specified by application policies, and identified within such policies using techniques that would become apparent to one of ordinary skill in the art after reading the descriptions herein.

One or more operations of method 200 may, in some approaches, include using the obtained capacity profiling information and descriptions described above for a predetermined efficient relatively fine-grained AI model architecture search. More specifically, such a search may be a sub-method to efficiently generate a wide range of architectures across relatively fine-grained memory requirements of the edge site where the selected AI model architecture will be deployed. The AI model architecture may, in some approaches, be an AI model. The AI model architecture may, in some approaches, additionally and/or alternatively include one or more specifications that detail, e.g., runtime details, minimum computing components, standards, etc., how to deploy the AI model to an edge device while performing a task at an edge site. At a relatively broad perspective, this sub-method determines a plurality of possible AI model architectures that may be deployed at such edge sites. More specifically, this sub-method aims to quickly generate a broad spectrum of possible AI model architectures tailored for specific edge device capacity specifications, utilizing a neural architecture search (NAS) framework.

Operation 204 includes determining, based on capacity profiling information and descriptions associated with a plurality of initial edge devices, a plurality of different possible AI model architectures that fulfill memory constraints of the initial edge devices. An illustrative process for determining the different possible AI model architectures is described below.

In some preferred approaches, one or more given state-of-the-art baseline model architectures for each task per edge device are determined and incorporated into the process of determining the different possible AI model architectures. In some approaches, one or more of these state-of-the-art baseline model architectures are identified on a predetermined global leaderboard. In some other approaches, one or more of these state-of-the-art baseline model architectures are additionally and/or alternatively identified as being present in a predetermined global model hub and/or predetermined model hosting servers. In yet some further approaches, one or more of these state-of-the-art baseline model architectures are additionally and/or alternatively determined by task-to-model-performance data banks. A given NAS framework setup of a type that would become apparent to one of ordinary skill in the art after reading the descriptions herein may also be used in the process of determining the different possible AI model architectures. For example, in some approaches, in order to determine the possible AI model architectures, method 200 includes generating a relatively wide range of possible model architectures across relativizing grained memory requirements by populating the predetermined NAS framework with search space parameters at a predetermined kernel level for a search space that is dependent on the task at hand and that includes a predetermined baseline state-of-the-art model architecture. In other words, the NAS framework may, in some approaches, be populated with the obtained capacity profiling information and descriptions in order to establish a relevant search. As indicated elsewhere above, memory may be considered a primary constraint because memory may be a major limitation for the deployment of edge AI models due to constrained hardware specifications at the edge sites. Accordingly, in some preferred approaches, in order to determine the possible AI model architectures, method 200 includes specifying memory as a primary constraint during the process of determining the different possible AI model architectures. In some approaches, memory may be specified as a primary constraint by of the plurality of initial edge devices.

The process of determining the different possible AI model architectures, in some approaches, additionally includes providing the predetermined NAS framework with a first list of the memory constraints of the initial edge devices and/or a general parameter range for the memory constrains. This way, the NAS framework has a search target upon which the search is based. For example, the predetermined NAS framework may, in some approaches, be instructed to search the search space for potential architectural modifications optimized as a multi-objective function. During this search, in some approaches, memory is listed as a hard constraint for the search. A second list of all models uncovered during the search of the search space may be generated, wherein the models uncovered during the search of the search space are at least the possible AI model architectures. Accordingly, each of the possible AI model architectures fulfill each of the memory constraints, and therefore the search yields multiple efficient models at different memory constraint levels for different tasks that may be performed at the different edge sites. The search results may then be mapped in a predetermined structured dictionary. For example, in some preferred approaches, mapping is performed in the structured dictionary, such that the possible AI model architectures of the second list are mapped to memory constraint bins. For context, in some preferred approaches, each of the memory constraint bins is associated with a different memory spectrum range that is based on memory constraints that different edge device tasks may require, e.g., edge devices having zero to five gigabytes of available storage potential, edge devices having more than five gigabytes of available storage potential to edge devices having ten gigabytes of available storage potential, edge devices having more than ten gigabytes of available storage potential to edge devices having thirty gigabytes of available storage potential, etc. Accordingly, this mapping process may include causing each possible AI model architecture to be sorted into one of the memory constraint bins having a memory spectrum range that matches memory constraints of the possible AI model architecture.

It should be noted that the techniques described above for determining the different possible AI model architectures determine all feasible model architectures that adhere to user-specified memory constraints, which is a major limiting factor for edge AI deployment. Notably, this determination is able to be performed without undergoing any specific training, which results in the techniques described herein having relatively streamlined outputs while using only relatively minimal processing resources. An outcome of these techniques is a structured mapping between different memory constraint bins and their corresponding model architecture variants in the form of a dictionary. This structured dictionary may be used in several additional operations of method 200, as will be described elsewhere below.

With the different possible AI model architectures determined and mapped to the constraint bins, in some approaches, method 200 additionally and/or alternatively includes performing one or more operations for generating a pareto-optimal configuration curve that illustrates the tradeoff between model latency and model task performance. For context, such a curve may be used to determine an AI model architecture to deploy to a given edge device in response to receiving a request from the edge device for specification of an AI model architecture. Furthermore, given the dictionary of mapping of the possible AI model architectures of the second list to memory constraint bins obtained as a result of performing the predetermined efficient relatively fine-grained model architecture search described above, these techniques for generating a pareto-optimal configuration curve aim to determine an optimal balance between model latency and task performance by leveraging the mapping within the dictionary.

Operation 206 includes optionally selecting a sub-set of the possible AI model architectures. A sub-set of the possible AI model architectures may be selected in order to reduce an amount of processing that is performed in evaluating the possible AI model architectures. Selecting the sub-set of the possible AI model architectures may include evenly selecting a plurality of memory constraint bins across a memory spectrum of the memory constraints of model tasks of the initial edge devices. As described elsewhere above, the memory spectrum of the memory constraint bins may include, e.g., edge devices having zero to five gigabytes of available storage potential, edge devices having more than five gigabytes of available storage potential to edge devices having ten gigabytes of available storage potential, edge devices having more than ten gigabytes of available storage potential to edge devices having thirty gigabytes of available storage potential, etc. In some approaches, selecting the sub-set of the possible AI model architectures includes performing the previously described sorting of the possible AI model architectures into the memory constraint bins according to the memory constraints of the possible AI model architectures. Sorting techniques that would become apparent to one of ordinary skill in the art after reading the descriptions herein may be used to perform this sorting. For example, in response to a determination that a memory constraint of a first of the possible AI model architectures calls for use of at least 3 gigabytes of memory, the first possible AI model architecture may be sorted into the memory constraint bin having a memory spectrum of zero to five gigabytes of available storage potential.

In some preferred approaches, given an evenly selected sub-set of “N” bins across the memory spectrum represented by the different memory constraint bins, selection of the sub-set of the possible AI model architectures may additionally and/or alternatively include selecting one possible AI model architecture from each of the different memory constraint bins. In other words, a relatively “best” possible AI model architecture is selected from each of the memory constraint bins to thereby establish a sub-set of relatively best possible AI model architectures. For context, in some approaches, for at least some of the memory constraint bins, a relatively “best” possible AI model architecture is selected by causing a neural architecture search (NAS) framework to identify, from each of the memory constraint bins, one of the possible AI model architectures for inclusion in the sub-set of the possible AI model architectures. Parameters that the NAS framework uses to identify the sub-set of the possible AI model architectures, in some approaches, include performance metrics of a type that would become apparent to one of ordinary skill in the art after reading the descriptions herein. For example, in some approaches, each of the identified possible AI model architectures of the sub-set of the possible AI model architectures may be identified by the NAS framework to have a potential for outperforming the other possible AI model architectures within the same memory constraint bin, e.g., with respect to accuracy of a model output, with respect to available processing resources, etc. In some approaches, this identification may be based on a test based evaluation of the performance of each of the possible AI model architectures. The NAS framework may consider past recorded performance metrics of the possible AI model architectures and/or estimated performance metrics of the possible AI model architectures (which may be estimated using techniques of a type that would become apparent to one of ordinary skill in the art after reading the descriptions herein).

Operation 208 includes training the sub-set of the possible AI model architectures until convergence. This training process preferably includes causing the sub-set of the possible AI model architectures to perform operations of one or more tasks of the edge devices in order to gauge how the models of the sub-set of the possible AI model architectures actually perform. Results observed during these performed operations are preferably then incorporated into a curve in order to illustrate the relative performances of the different possible AI model architectures. For example, in some approaches, method 200 includes generating a pareto-optimal configuration curve based on the sub-set of the possible AI model architectures, e.g., see operation 210. Generating the pareto-optimal configuration curve includes plotting a plurality of points each associated with a different one of the possible AI model architectures. More specifically, the curve is preferably a memory consumption versus task performance curve that is fit against the points, such that each point along the curve represents a coarse-grained range of the different possible AI model architectures selected by the NAS framework. In order to plot the curve with respect to memory consumption versus task performance, in some approaches, the points are plotted (in a two-dimensional graph) with respect to a first axis that is based on model latency, and furthermore, the points may be plotted with respect to a second axis that is based on model task performance.

In some approaches, detail may be added to the pareto-optimal configuration curve by determining additional possible AI model architectures, e.g., thereby enabling ongoing refinement of the pareto-optimal configuration curve. In order to determine these additional possible AI model architectures, method 200, in some approaches, includes training a regression model to generate a pareto-optimal configuration curve, e.g., see operation 212. In some preferred approaches, the regression model is a polynomial regression model. In some other approaches, the model may support a vector machine, be a neural network (NN)-based model, etc. Furthermore, the existing points of the pareto-optimal configuration curve may be used as input to train the regression model using techniques that would become apparent to one of ordinary skill in the art after reading the descriptions herein. More specifically, the regression model is trained using the points of the pareto-optimal configuration curve to predict model performance versus inference latency. Furthermore, the model may additionally and/or alternatively be trained on the gathered data points with the goal of predicting task performance based on memory usage inputs, which may be used as feedback for future predictions. For example, in response to a determination that the regression model understands how the existing points were determined and added to the pareto-optimal configuration curve, e.g., achieves a predetermined threshold of accuracy based on using the existing points of the pareto-optimal configuration curve as training data, the trained regression model may be used, e.g., instructed, to determine additional possible AI model architectures, e.g., see operation 214. In some approaches, the trained model may determine additional latency requirements by employing another NAS search. The additional possible AI model architectures are, in some preferred approaches, incorporated into the pareto-optimal configuration curve by adding points to the pareto-optimal configuration curve to represent the additional possible AI model architectures, e.g., see operation 216.

Operation 218 includes storing all the trained possible AI model architectures in a predetermined model bank. For context, the predetermined model bank may be thereafter referenced and used to determine one of the possible AI model architectures with a relatively highest degree of adherence to constraints of a given edge device. For example, various operations below describe a process for relatively efficient pareto-optimal configuration curve interpolation and model deployment that may be used to determine, provision and deploy an AI model architecture variant based on edge-device capacity requirements.

In some approaches, the AI model architecture variant may be determined for an edge device in response to receiving a request to do so. For example, operation 220 includes receiving a request for determining an AI model architecture for a first edge device. In some approaches, the request is a request of a foundation model to be provided as a serviceable new adapted model. In order to fulfill the request, method 200 may, in some preferred approaches, include using the pareto-optimal configuration curve to determine the possible AI model architecture within the predetermined model bank with the relatively highest degree of adherence to constraints of the first edge device. In order to make such a determination, constraints of the first edge device may need to be determined first. Accordingly, in some approaches, method 200 includes obtaining capacity profiling information and descriptions associated with the first edge device, e.g., see operation 222. This information and descriptions may, in some approaches, be included in the request as a task model. For context, a “task model” may include descriptions and/or information associated with a task that is performed by the first edge device at the first edge site. In some other approaches, the information and descriptions may be obtained by other means, e.g., issuing a query to the first edge device, accessing a file that includes the information and descriptions, etc. In some approaches, the capacity profiling information and descriptions associated with the first edge device may include the first edge device's hardware specifications, e.g., memory limits, type of computational devices included in and/or used by the first edge device, capacity profile and desired inference latency bounds, etc. The capacity profiling information and descriptions associated with the first edge device may, in some approaches, be determined, e.g., extracted using techniques such as NLP that would become apparent to one of ordinary skill in the art after reading the descriptions herein, from system requirements of the first edge device. In some other approaches, the capacity profiling information and descriptions associated with the first edge device may, additionally and/or alternatively be determined by performing capacity profiling of the first edge device over time. Furthermore, the capacity profiling information and descriptions associated with the first edge device may, in some approaches, additionally and/or alternatively be based on and/or determined using a resource availability history of the first edge device. The capacity profiling information and descriptions associated with the first edge device may, in some other approaches, additionally and/or alternatively be inferred by other model-based approaches such as machine learning models of a type that would become apparent to one of ordinary skill in the art after reading the descriptions herein.

With specifications about the edge device capabilities, e.g., memory, computation, etc., obtained for the first edge device method 200 preferably includes consulting the pareto-optimal configuration curve to identify a relatively highest-performing model that fits the first edge device's memory constrains. For example, operation 224 of method 200 includes using the pareto-optimal configuration curve to determine one of the possible AI model architectures with a relatively highest degree of adherence to constraints of the first edge device, in response to receiving the request for determining the AI model architecture for the first edge device. In some approaches, using the pareto-optimal configuration curve to determine one of the possible AI model architectures with a relatively highest degree of adherence to constraints of the first edge device includes causing a predetermined AI-latency-interference-framework of a type that would be understood by one of ordinary skill in the art after reading the descriptions herein to derive a latency requirement to use for determining the one of the possible AI model architectures with the relatively highest degree of adherence to constraints, e.g., preferably determined memory constrains, of the first edge device. For context, the AI-latency-interference-framework, may, in some approaches, be a software tool designed to predict the time required for a Deep Neural Network (DNN) model to perform an inference task. A primary objective of such a framework may be to estimate the inference latency of DNN models. This may be particularly applicable in real-time applications where processing speed is critical, and furthermore helps in decision-making regarding model optimization and hardware selection. This objective may, in some approaches, be achieved by breaking down a DNN model into smaller, manageable units. The time taken by each of these units to execute a task is incorporated into a determination of the predicted overall latency. Tasks of implementing the AI-latency-interference-framework may, in some approaches, include unit identification, during which the framework identifies distinct execution units within a DNN model, and latency prediction, during which the framework estimates the time each unit will take to process data in order to determine a total sum latency.

In some approaches, the derived latency requirement characterizes an amount of processing performance latency that the first edge device will accept in the event that a determined one of the possible AI model architectures is deployed to the first edge device. For context, in some approaches, by using the predetermined AI-latency-interference-framework, techniques described herein provide an interpolation of the pareto-optimal configuration curve to identify the AI model architectures with a model that additionally satisfies the given latency bounds.

In some approaches, the interpolation of the pareto-optimal configuration curve is iteratively performed to identify the AI model architectures with a model that additionally satisfies the given latency bounds. In other words, a first of the considered possible AI model architectures may be determined to not satisfy the latency requirement and a memory requirement of the first edge device, and therefore one or more additional possible AI model architectures may be considered. In some approaches, this iterative process includes first estimating the latency and adjusting a considered AI model architecture further via employing the predetermined AI-latency-interference-framework to derive the latency for the chosen AI model architecture on the first edge device. In response to a determination that the latency of a considered one of the possible AI model architectures exceeds the desired bounds of the obtaining capacity profiling information and descriptions associated with the first edge device, iterative adjustments, e.g., of a predetermined amount of memory, may be performed to the memory constraints that are applied to the consideration of the possible AI model architectures, and the predetermined AI-latency-interference-framework may be caused to consider the pareto-optimal prediction curve again.

The iterative process described above is, in some approaches, preferably performed until a suitable AI model architecture that adheres to constraints, e.g., preferably both memory and latency requirements, of the first edge device is identified. In other words, a result of the iterative process includes an exact model specification that is specified by the determined AI model architecture. An optional step of method 200 includes determining whether any of the possible AI model architectures satisfy the latency requirement and the memory requirement of the first edge device, e.g., see decision 226. This determination may be performed as a precaution in case none of the possible AI model architectures satisfy the latency requirement and the memory requirement of the first edge device.

Because the AI model architectures are, in preferred approaches, determined and stored in the predetermined model bank before any model deployment requests are received, in some cases, the AI model architectures that exist in the predetermined model bank at the time that a request is received may not satisfy the latency requirement and/or memory requirements of an edge device associated with a received request, e.g., such as the first edge device. As will now be described below, in response to a determination that a suitable model cannot be identified (to satisfy a new model request) in the predetermined model bank, the NAS framework is preferably caused to be run again on the basis of a relatively “closest configuration”. For example, in response to a determination that none of the possible AI model architectures satisfy the latency requirement and a memory requirement of the first edge device, e.g., as illustrated by the “NO” logical path of decision 226, an attempt is made to obtain a new AI model architecture, e.g., see operation 228. In some preferred approaches, obtaining a new AI model architecture includes performing one or more of the steps that were previously performed to obtain the plurality of possible AI model architectures that fulfill memory constraints of the initial edge devices. For example, in some approaches, new possible AI model architectures may be determined by checking back with results of the NAS framework, and picking a model of a memory bin that is relatively closest to a predetermined target, e.g., where the target is defined by memory constraints of the received request. The NAS framework may be caused to run again with the populated configurations to achieve a relatively finer-grained memory binning, up until a possible AI model architecture is determined to satisfy the latency requirement and a memory requirement of the received request, e.g., thereby establishing a “new AI model architecture” to use to fulfill the request. The new AI model architecture is then used as the determined AI model architecture. In some approaches, the new AI model architecture is stored in the predetermined model bank in order to further diversify the possible AI model architectures that are considered while fulfilling a next request from an edge device for an AI model architecture, e.g., see operation 230. Operation 232 includes causing the new AI model architecture to be deployed to the first edge device. In some approaches, causing the new AI model architecture to be deployed to the first edge device includes causing the new AI model architecture to be provisioned by a FMaaS and deployed onto the constrained first edge device.

In contrast, in some approaches, a determination is made that at least one of the possible AI model architectures satisfy the latency requirement and a memory requirement of the first edge device, e.g., as illustrated by the “YES” logical path of decision 226. In response to such a determination, the determined AI model architecture is, in some preferred approaches, caused to be provisioned and deployed to the constrained first edge device, e.g., see operation 234.

The operations of method 200 described above relatively efficiently derive fine-grained AI model architectures, generate Pareto-Optimal decisions which balance model latency, resource utilization and performance, and furthermore provision and deploy optimal AI model architecture variants tailored to the unique capacity requirements at a constrained edge. The techniques described in embodiments and approaches herein offer distinguishable differences over conventional techniques. For example, it should be noted that the techniques described herein are distinguishable from model compression, which otherwise focuses on techniques for reducing the number of trainable parameters of deep learning models. Compression techniques ultimately refer to a single compressed model, while the techniques described herein generate multiple AI model architectures with varying sizes, each fitting within a given set of constraints and use cases while maintaining the size-to-performance latency. Accordingly, the techniques described herein are unique in that they consider a model bank instead of a model compression mechanism to generate a single model.

Furthermore, the techniques described herein are distinguishable and non-obvious over standard AI model orchestration techniques, as these conventional orchestration techniques typically deploy pretrained models in a generalized framework. In sharp contrast, the techniques described herein consider and incorporate the unique constraints of edge environments and dynamically generate or suggest AI model architecture variants based on specific edge device requirements. In some approaches, the novel techniques described herein use a combination of techniques such as NAS for on-the-fly model derivation and incorporate the generation of pareto-optimal decision curves, which is not performed in conventional techniques.

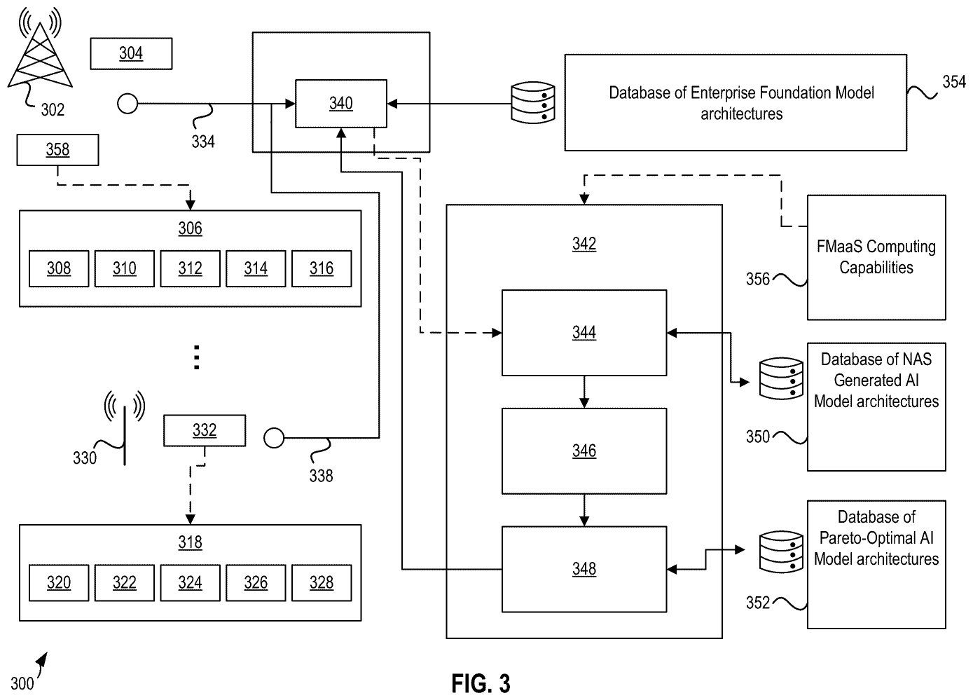

FIG. 3 depicts an edge computing environment 300, in accordance with one embodiment. As an option, the present edge computing environment 300 may be implemented in conjunction with features from any other embodiment listed herein, such as those described with reference to the other FIGS. Of course, however, such edge computing environment 300 and others presented herein may be used in various applications and/or in permutations which may or may not be specifically described in the illustrative embodiments listed herein. Further, the edge computing environment 300 presented herein may be used in any desired environment.

It may be prefaced that, edge computing environment 300 serves as an infrastructure for a scenario in which a FMaaS provider distributes a resource efficient AI model architecture variant to a constrained edge. Approaches described below ensure a relatively efficient computation of pareto-optimal capacity performance curves for several different compressed, pruned or altered AI model architecture specifications such that the AI model architectures do not need to be extensively searched, but may rather be relatively quickly inferred for dynamic edge applications of edge devices with different respective capacity specifications. To achieve this, three portions of a process 342 may be performed. At a relatively high level, the process includes a first portion for deriving relatively fine-grained AI model architecture representations, a second portion for determining and mapping AI model architecture performances to various capacity specifications in order to derive a pareto-optimal configuration curve, and a third portion for interpolating an existing pareto-optimal configuration curve intelligently so as to discretize the diagram to suitable configurations for different edge devices. By combining these techniques, an adaptive, edge-centric solution is created that addresses the specific challenges of deploying AI models on an IoT-edge-cloud continuum.

The edge computing environment 300 includes a plurality of client edge sites. For example, a first edge site includes a first antenna 302 and a first edge device 304. A use case task 306 performed at the first edge site includes a plurality of sub-tasks for performing an industrial visual inspection, e.g., see sub-tasks 308-316. Any number of edge sites may be included in the edge computing environment 300. For example, a N^{th} edge site includes a second antenna 330 and a second edge device 332. A use case task 318 performed at the first edge site includes a plurality of sub-tasks for performing an industrial visual inspection, e.g., see sub-tasks 320-328.

FMaaS requests and/or capacity profiling information may be accessed and/or received on a FMaaS provisioning instance module 340, e.g., see operations 334 and 338. This information may be used to perform the process 342 that includes operations similar to the various operations and techniques described in method 200. For example, a first portion 344 of the process 342 may be used to perform an efficient relatively fine-grained AI model architecture search. More specifically, such a search may be a sub-method to efficiently generate a wide range of architectures across relatively fine-grained memory requirements of one of the edge sites where the selected AI model architecture will be deployed. A second portion 346 of the process 342 may be used to generate a pareto-optimal configuration curve based on a sub-set of the possible AI model architectures determined in the first portion 344 of the process 342. Finally, a third portion 348 of the process 342 uses the pareto-optimal configuration curve to select and deploy one of the AI model architectures to one of the edge devices, e.g., see input 358. It may be noted that, in some approaches, one or more FMaaS computing capabilities 356 may be used in the process 342 to determine constrains.

The process 342 may rely on information stored in one or more databases in some approaches, e.g., see database of NAS generated AI Model architectures 350 and database of pareto-optimal AI model architectures 352. Furthermore, information determined during the process 342 may be stored in one or more of such databases. For example, in some approaches, possible AI model architectures, trained AI model architectures and/or new AI model architectures may be stored in a database of Enterprise foundation model architectures 354.

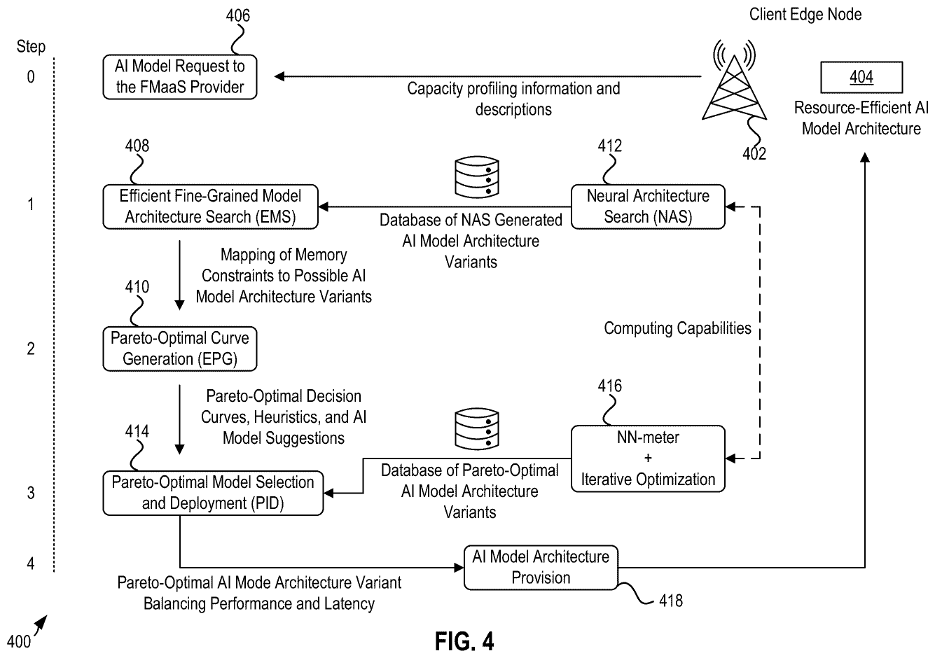

Now referring to FIG. 4, a flowchart of a method 400 is shown according to one embodiment. The method 400 may be performed in accordance with the present invention in any of the environments depicted in FIGS. 1-4, among others, in various embodiments. Of course, more or fewer operations than those specifically described in FIG. 4 may be included in method 400, as would be understood by one of skill in the art upon reading the present descriptions.

Each of the steps of the method 400 may be performed by any suitable component of the operating environment. For example, in various embodiments, the method 400 may be partially or entirely performed by a processing circuit, or some other device having one or more processors therein. The processor, e.g., processing circuit(s), chip(s), and/or module(s) implemented in hardware and/or software, and preferably having at least one hardware component, may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

The flowchart of method 400 illustrates an end-to-end workflow of techniques that may be used within a FMaaS setup to determine a suitable AI model architecture to deploy at an edge site based on constraints of an edge device of the edge site. At a relatively high level, in the proposed setup, a new user device and/or a new AI task is introduced at an edge site and a potential FMaaS or other AI hosting entities are requested to provision the client edge device with a requested AI model architecture. Because the client edge device may be constrained, relatively high-performance and low-latency AI model architecture may yield system requirements which are not supported by the edge device. As such, the model revision process described below may be initiated which determines a deployable variant of the AI model architecture.

In a first step (see Step “0”) of method 400, a client edge node that includes an antenna 402 and an edge device 404 outputs capacity profiling information and descriptions in a request received by an FMaaS provider, e.g., see operation 406. The request, in some preferred approaches, includes capacity profiling information and descriptions of an AI model task performed by the edge device at the client edge node.

In a second step (see Step “1”) of method 400, in some approaches, a relatively efficient fine-grained model architecture search is performed, e.g., see operation 408 using techniques described elsewhere above, e.g., see method 200. A result of performing operation 408 includes memory constraints being mapped to possible AI model architecture variants. In some approaches, the possible AI model architecture variants are determined using a computing capabilities such as NAS 412, e.g., see operation 410. Furthermore, the possible AI model architecture variants may, in some approaches, be stored in a database of NAS generated AI model architecture variants.

In a third step (see Step “2”) of method 400, in some approaches, a pareto-optimal configuration curve is generated, e.g., see operation 410, using techniques described elsewhere above, e.g., see method 200. A result of performing operation 410 includes pareto-optimal decision curves, heuristics, and AI model architecture suggestions.

In a fourth step (see Step “3”) of method 400, in some approaches, pareto-optimal model architecture selection and deployment operations are performed, e.g., see operation 414. This operation may include the use of computing capabilities such as predetermined AI-latency-interference-framework and iterative optimization, e.g., operation 416, as described elsewhere herein, and a database of pareto-optimal AI model architecture variants may be updated to include any new or retrained AI model architectures. In a fifth step (see Step “4”) of method 400 the determined AI model architecture, that balances performance and latency constraints is provisioned, e.g., operation 418, for deployment on a requesting edge device, e.g., see resource-efficient AI model architecture.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
determining, based on capacity profiling information and descriptions associated with a plurality of initial edge devices, a plurality of possible AI model architectures that fulfill memory constraints of the initial edge devices;
generating a pareto-optimal configuration curve based on a sub-set of the possible AI model architectures;
in response to receiving a request for determining an AI model architecture for a first edge device, using the pareto-optimal configuration curve to determine one of the possible AI model architectures with a relatively highest degree of adherence to constraints of the first edge device; and
causing the determined AI model architecture to be deployed to the first edge device.

2. The computer-implemented method of claim 1, wherein determining the possible AI model architectures includes:
populating a predetermined neural architecture search (NAS) framework with search space parameters at a predetermined kernel level for a search space that includes a predetermined baseline model architecture;
specifying memory as a primary constraint of the plurality of initial edge devices;
providing the predetermined NAS framework with a first list of the memory constraints of the initial edge devices;
instructing the predetermined NAS framework to search the search space for potential architectural modifications optimized as a multi-objective function;
generating a second list of all models uncovered during the search of the search space, wherein the models uncovered during the search of the search space are the possible AI model architectures, wherein each of the possible AI model architectures fulfill each of the memory constraints; and
mapping, in a structured dictionary, the possible AI model architectures of the second list to memory constraint bins.

3. The computer-implemented method of claim 1, comprising:
selecting the sub-set of the possible AI model architectures;
training the sub-set of the possible AI model architectures until convergence,
wherein generating the pareto-optimal configuration curve includes plotting a plurality of points each associated with a different one of the possible AI model architectures; and
storing the trained possible AI model architectures in a predetermined model bank.

4. The computer-implemented method of claim 3, wherein the points are plotted with respect to a first axis that is based on model latency, wherein the points are plotted with respect to a second axis that is based on model task performance.

5. The computer-implemented method of claim 3, wherein selecting the sub-set of the possible AI model architectures includes:
evenly selecting a plurality of memory constraint bins across a memory spectrum of the memory constraints of model tasks of the initial edge devices,
sorting the possible AI model architectures into the memory constraint bins according to the memory constraints of the possible AI model architectures, and
causing a neural architecture search (NAS) framework to identify, from each of the memory constraint bins, one of the possible AI model architectures for including in the sub-set of the possible AI model architectures,
wherein each of the identified possible AI model architectures is identified by the NAS framework to have a potential for outperforming the other possible AI model architectures within the same memory constraint bin.

6. The computer-implemented method of claim 3, comprising:
training, using the points, a regression model to generate a pareto-optimal configuration curve;
using the trained regression model to determine additional possible AI model architectures; and
incorporating the additional possible AI model architectures into the pareto-optimal configuration curve by adding points to the pareto-optimal configuration curve to represent the additional possible AI model architectures.

7. The computer-implemented method of claim 1, comprising:
obtaining, the capacity profiling information and descriptions,
wherein the capacity profiling information includes memory constraint specifications of the initial edge devices,
wherein the descriptions include tasks performed by the initial edge devices.

8. The computer-implemented method of claim 1, wherein using the pareto-optimal configuration curve to determine the possible AI model architecture with the relatively highest degree of adherence to constraints of the first edge device includes:
obtaining capacity profiling information and descriptions associated with the first edge device; and
causing a predetermined AI-latency-interference-framework to derive a latency requirement to use for determining the one of the possible AI model architectures with the relatively highest degree of adherence to constraints of the first edge device.

9. A computer program product, the computer program product comprising a computer readable storage medium having program instructions embodied therewith, the program instructions readable and/or executable by a processing circuit to cause the processing circuit to:
determine, based on capacity profiling information and descriptions associated with a plurality of initial edge devices, a plurality of possible AI model architectures that fulfill memory constraints of the initial edge devices;
generate a pareto-optimal configuration curve based on a sub-set of the possible AI model architectures;
in response to receiving a request for determining an AI model architecture for a first edge device, use the pareto-optimal configuration curve to determine one of the possible AI model architectures with a relatively highest degree of adherence to constraints of the first edge device; and
cause the determined AI model architecture to be deployed to the first edge device.

10. The computer program product of claim 9, wherein determining the possible AI model architectures includes:
populating a predetermined neural architecture search (NAS) framework with search space parameters at a predetermined kernel level for a search space that includes a predetermined baseline model architecture;
specifying memory as a primary constraint of the plurality of initial edge devices;
providing the predetermined NAS framework with a first list of the memory constraints of the initial edge devices;
instructing the predetermined NAS framework to search the search space for potential architectural modifications optimized as a multi-objective function;
generating a second list of all models uncovered during the search of the search space, wherein the models uncovered during the search of the search space are the possible AI model architectures, wherein each of the possible AI model architectures fulfill each of the memory constraints; and
mapping, in a structured dictionary, the possible AI model architectures of the second list to memory constraint bins.

11. The computer program product of claim 9, the program instructions readable and/or executable by the processing circuit to cause the processing circuit to:
select the sub-set of the possible AI model architectures;
train the sub-set of the possible AI model architectures until convergence,
wherein generating the pareto-optimal configuration curve includes plotting a plurality of points each associated with a different one of the possible AI model architectures; and
store the trained sub-set of possible AI model architectures in a predetermined model bank.

12. The computer program product of claim 11, wherein the points are plotted with respect to a first axis that is based on model latency, wherein the points are plotted with respect to a second axis that is based on model task performance.

13. The computer program product of claim 11, wherein selecting the sub-set of the possible AI model architectures includes:
evenly selecting a plurality of memory constraint bins across a memory spectrum of the memory constraints of model tasks of the initial edge devices,
sorting the possible AI model architectures into the memory constraint bins according to the memory constraints of the possible AI model architectures, and
causing a neural architecture search (NAS) framework to identify, from each of the memory constraint bins, one of the possible AI model architectures for including in the sub-set of the possible AI model architectures,
wherein each of the identified possible AI model architectures is identified by the NAS framework to have a potential for outperforming the other possible AI model architectures within the same memory constraint bin.

14. The computer program product of claim 11, the program instructions readable and/or executable by the processing circuit to cause the processing circuit to:
train, using the points, a regression model to generate a pareto-optimal configuration curve;
use the trained regression model to determine additional possible AI model architectures; and
incorporate the additional possible AI model architectures into the pareto-optimal configuration curve by adding points to the pareto-optimal configuration curve to represent the additional possible AI model architectures.

15. The computer program product of claim 9, the program instructions readable and/or executable by the processing circuit to cause the processing circuit to:
obtain, the capacity profiling information and descriptions,
wherein the capacity profiling information includes memory constraint specifications of the initial edge devices,
wherein the descriptions include tasks performed by the initial edge devices.

16. The computer program product of claim 9, wherein using the pareto-optimal configuration curve to determine the possible AI model architecture with the relatively highest degree of adherence to constraints of the first edge device includes:
obtaining capacity profiling information and descriptions associated with the first edge device; and
causing a predetermined AI-latency-interference-framework to derive a latency requirement to use for determining the one of the possible AI model architectures with the relatively highest degree of adherence to constraints of the first edge device.

17. A system, comprising:
a processor; and
logic integrated with the processor, executable by the processor, or integrated with and executable by the processor, the logic being configured to:
determine, based on capacity profiling information and descriptions associated with a plurality of initial edge devices, a plurality of possible AI model architectures that fulfill memory constraints of the initial edge devices;
generate a pareto-optimal configuration curve based on a sub-set of the possible AI model architectures;
in response to receiving a request for determining an AI model architecture for a first edge device, use the pareto-optimal configuration curve to determine one of the possible AI model architectures with a relatively highest degree of adherence to constraints of the first edge device; and
cause the determined AI model architecture to be deployed to the first edge device.

18. The system of claim 17, wherein determining the possible AI model architectures includes:
populating a predetermined neural architecture search (NAS) framework with search space parameters at a predetermined kernel level for a search space that includes a predetermined baseline model architecture;
specifying memory as a primary constraint of the plurality of initial edge devices;
providing the predetermined NAS framework with a first list of the memory constraints of the initial edge devices;
instructing the predetermined NAS framework to search the search space for potential architectural modifications optimized as a multi-objective function;
generating a second list of all models uncovered during the search of the search space, wherein the models uncovered during the search of the search space are the possible AI model architectures, wherein each of the possible AI model architectures fulfill each of the memory constraints; and
mapping, in a structured dictionary, the possible AI model architectures of the second list to memory constraint bins.

19. The system of claim 17, the logic being configured to:
select the sub-set of the possible AI model architectures;
train the sub-set of the possible AI model architectures until convergence,
wherein generating the pareto-optimal configuration curve includes plotting a plurality of points each associated with a different one of the possible AI model architectures; and
store the trained possible AI model architectures in a predetermined model bank.

20. The system of claim 19, wherein the points are plotted with respect to a first axis that is based on model latency, wherein the points are plotted with respect to a second axis that is based on model task performance.
